(19) United States
(12) Patent Application Publication
(10) Pub. No.: US 2012/0151144 A1
(43) Pub. Date: Jun. 14, 2012

(54) METHOD AND SYSTEM FOR DETERMINING A CACHE MEMORY CONFIGURATION FOR TESTING

(76) Inventor: William Judge Yohn, River Falls, WI (US)

(21) Appl. No.: 12/962,767

(22) Filed: Dec. 8, 2010

(51) Int. Cl. G06F 12/08; G06F 12/02

(52) U.S. Cl. 711/122; 711/E12.024; 711/E12.043; 711/E12.038

(57) ABSTRACT

A method and computer device for determining the cache memory configuration. The method includes allocating an amount of cache memory from a first memory level of the cache memory, and determining a read transfer time for the allocated amount of cache memory. The allocated amount of cache memory then is increased and the read transfer time for the increased allocated amount of cache memory is determined. The allocated amount of cache memory continues to be increased and the read transfer time determined for the each allocated amount until all of the cache memory in all of the cache memory levels has been allocated. The cache memory configuration is determined based on the read transfer times from the allocated portions of the cache memory. The determined cache memory configuration includes the number of cache memory levels and the respective capacities of each cache memory level.

### BACKGROUND

1. Field

The instant disclosure relates generally to cache memory configurations within computer systems, and more particularly, to determining cache memory configurations for cache memory testing purposes.

2. Description of the Related Art

Within computer systems, cache memory is used to store the contents of a typically larger, slower memory component of the computer system. It would be useful to be able to accurately determine the configuration of the cache memory of a computer system, particular a relatively large scale computer system, for purposes of being able to adequately test the cache memory.

Conventionally, for existing products, the problems associated with determining the configuration of a computer system's cache memory have not been adequately solved. During past development cycles, relatively little thought was given to the need for generating predictable and reproducible test coverage for cache memory that has a relatively large and complex configuration. Such configuration may contain multiple units in multiple configuration levels. A particular piece of data may exist in any unit and may be accessed by a multiplicity of different paths. Previous test efforts focused on executing discrete functional tests, either individually or in random combinations, with the intent of producing system load and combinatorial conditions that would exacerbate system design failures.

The result of these conventional efforts was to produce a system load that either followed a specific set of characteristics (grooved activity) or was completely random in nature. The “grooved” activity produced a very limited set of test conditions, while the random activity required too much time to detect even a limited number of combinatorial errors. Also, previous test programs did relatively little to optimize throughput and functionality, e.g., by distributing the processing tasks to independent processing activities. As a result, the number of problems that were undetected at the time of a system release typically was much greater than desired, which contributed to the overall development cycle typically being unnecessarily long. An additional and relatively significant shortcoming of previous testing approaches is that most results were non-deterministic. Often, it was relatively difficult to determine what access patterns were being used at the time of a failure and even more difficult to reproduce them deterministically. Desired test methods and systems should allow for both a relatively high degree of deterministic functional and load testing to take place, with results that are considerably more reproducible compared to conventional test results.

### SUMMARY

Disclosed is a method, system and computer device for determining the cache memory configuration of a large scale computer system in such a way that the cache memory configuration can be used as the input for a comprehensive and reproducible cache memory test package. The method includes allocating an amount of cache memory from a first memory level of the cache memory, and determining a read transfer time for the allocated amount of cache memory, e.g., by writing data in each of a group of portions of the allocated amount of cache memory, reading the data from each of the portions of the allocated amount of cache memory, and calculating the read transfer time based on the amount of time required to write the data to and read the data from the allocated amount of cache memory. Alternatively, the write timing can be calculated to determine the write/read timing differential. The allocated amount of cache memory then is increased and the read transfer time for the increased allocated amount of cache memory is determined. The allocated amount of cache memory continues to be increased and the read transfer time determined for each allocated amount until all of the cache memory in all of the cache memory levels has been allocated. The cache memory configuration is determined based on the read transfer times from the allocated portions of the cache memory. The determined cache memory configuration includes the number of cache memory levels and the respective capacities of each cache memory level.

### BRIEF DESCRIPTION OF THE DRAWINGS

FIG. 1 is a schematic view of a very large scale mainframe computer cache memory hierarchy;

FIG. 2 is a schematic view of a portion of a general system memory hierarchy as it relates to a process for detecting the cache memory levels and determining their respective data capacities and access times according to an embodiment;

FIG. 3 is a schematic view of a portion of a general system memory hierarchy, showing the distinct levels of main memory with attendant difference in requestor to data timing;

FIG. 4 is a schematic view of a table built according to an embodiment, showing what data resides as what timing levels for each data requestor;

FIG. 5 is a schematic view of a portion of a general system memory hierarchy, showing the distinct levels of main memory with attendant difference in requestor to data timing from the perspective of the main memory (MEM) units;

FIG. 6 is a flow diagram of a method for determining the configuration of a computer system cache memory unit; and

FIG. 7 is a schematic view of an apparatus configured to determine the configuration of a computer system cache memory unit and/or to test the cache memory unit according to an embodiment.

### DETAILED DESCRIPTION

In the following description, like reference numerals indicate like components to enhance the understanding of the disclosed methods and systems through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

As used in this description, the terms “component,” “module,” and “system,” are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets, e.g., data from one component interacting with another component in a local system, distributed system, and/or across a network, such as the Internet, with other systems by way of the signal.

Throughout the development of large scale computer system cache memory architectures, there continues to be a consistent problem associated with providing a mechanism to be used as the basis for testing an implementation of a given such architecture with an improved degree of functional coverage and efficiency. Another persistent problem is the ability to reproduce any test conditions that have resulted in a system failure.

The relative difficulty in testing this type of computer architecture to date is partially the result of a number of related conditions becoming relevant more or less simultaneously as computer systems developed have developed. As more people began using computer systems, the requirement to be able to process larger computer programs became more important. Also, the need to process a number of such programs simultaneously became a relevant consideration. To facilitate this need, larger amounts of system memory began to be employed.

However, at the same time, it was observed that not all parts of a computer program were used at the same rate and for the same amount of time. This gave rise to the concept of having a smaller but faster memory structure that would contain the parts of a program that were used more often, thus facilitating an increase in the speed at which a given program would execute. As computer systems evolved, it was observed that multiple hierarchical layers of memory would be necessary to improve program execution and reduce implementation costs. The intermediate layers of computer memory became known as cache memory units, levels or layers. The cache memory layer or level that resides closest to the requestors, such as central processing units (CPU), is both the smallest and the fastest of the cache memory levels, and is generally known as Level 1 cache (L1). Each succeeding layer or level is both larger and slower than the preceding layer or level. This cache memory structure ultimately culminates in a layer or level that generally known as the main memory or system memory.

Many modern computer architectures contain 3 levels of cache memory (e.g., Level 1 or L1, Level 2 or L2, and Level 3 or L3), as well as a level of main memory (MEM), in addition to internal CPU registers. In most architectures, the Level 1 cache memory is integrated into the CPU ASIC (application specific integrated circuit). The Level 1 cache memory often is subdivided into 2 sections: one section that contains program instructions and one section that contains program data referred to as instruction operands. Typically, the Level 2 and Level 3 cache memory levels are integrated into the CPU ASIC as well. In some other architectures, the Level 2 and/or Level 3 cache memory levels are contained in separate ASICs located near the requestor ASICs on a system motherboard. Also, the main or system memory layer or level may be located near the requestor ASIC on a system motherboard. Finally, many of the latest computer architectures have been developed in such a way that multiple CPUs can be contained on the same physical ASIC and share an integrated Level 2 cache memory unit. The tabular listing below summarizes a general system memory hierarchy:

Computer System Memory Hierarchy (Fastest to Slowest Access Times):

1. Internal CPU storage registers (on CPU ASIC)—1 CPU clock cycle

2. Level 1 (L1) cache memory—1-3 clock cycles latency—size: 10 KB+

3. Level 2 (L2) cache memory—latency higher than L1—size: 500 KB+

4. Level 3 (L3) cache memory—latency higher than L2—size: 1 MB+

5. Main memory—many clock cycles size: 64 GB+

6. Disk mass storage—millisecond access-size: capacity limited by disk number (many terabytes)

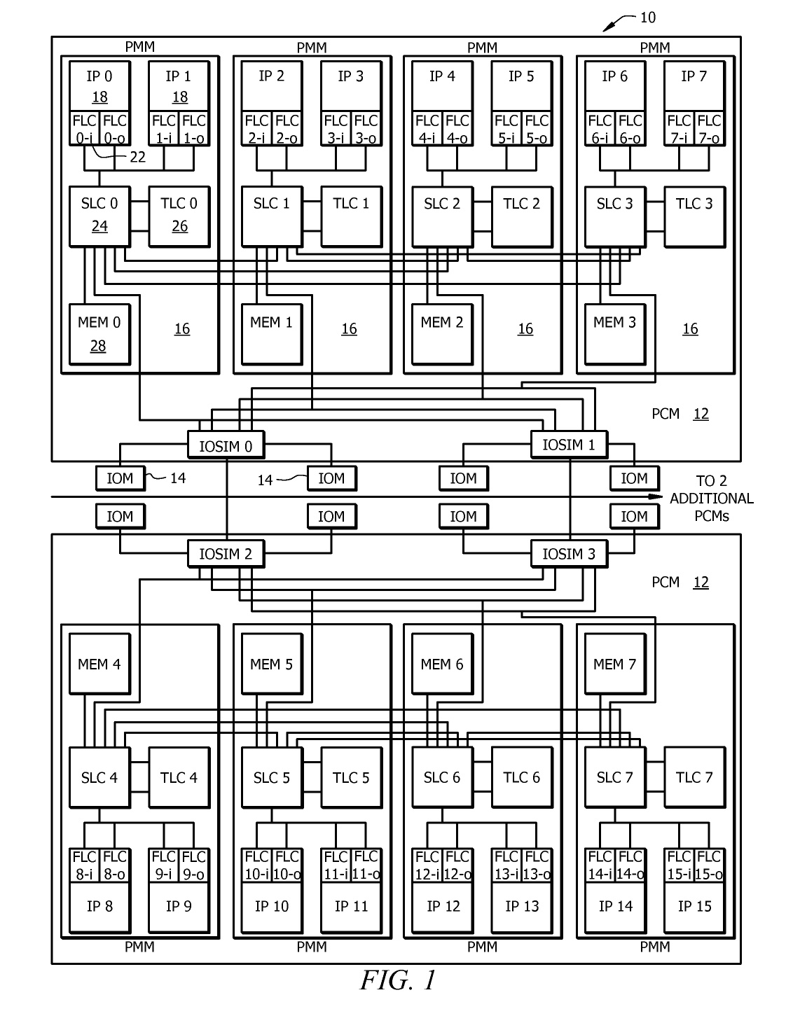

FIG. 1 is a schematic view of a portion of a very large scale mainframe computer cache memory hierarchy 10. The entire cache memory hierarchy 10 includes four (4) processor control module (PCM) cells 12, although only two (2) PCM cells 12 are shown in FIG. 1. Each PCM cell 12 has two (2) I/O modules (IOMs) 14 and four (4) processor modules (PMMs) 16. Each PMM 16 includes 2 central processing units or CPUs (IPs) 18, each with an integrated Level 1 (FLC—first level cache) cache memory unit 22. Each PMM 16 also includes a shared Level 2 (SLC—second level cache) cache memory unit 24, a shared Level 3 (TLC—third level cache) cache memory unit 26, and a main memory (MEM) unit 28.

As can be seen from the cache memory hierarchy 10, the number of paths a piece of data can take when being accessed by a set of requestors is incredibly large. In the case of a computer system that contains sixteen (16) instruction processors, the number of combinations of requests to manipulate a specific piece of data by sixteen processors at a time is 2¹⁶−1. For a similar configuration containing thirty two (32) instruction processors, the number of requests to manipulate a particular piece of data rises to 2³²−1. If requested data is resident in one of the cache memory units (e.g., SLC 24 or TLC 26), the data will be retrieved from the particular cache memory unit there. If the data is subsequently modified by the requestor, the initial copy retrieved from the cache memory unit no longer will be valid and therefore will be declared invalid and removed from the cache memory unit. The new modified data will be made resident in the cache memory unit(s) of the modifying requestor and eventually will be written back to main memory unit 28. The next time a requestor asks for that piece of data, the data will be retrieved from the modifying requestor's cache memory unit or from the memory unit, depending on the architectural implementation of the MESI (Modified Exclusive Shared Invalid) cache protocol.

This type of cache memory architecture contains four (4) levels of cache memory, each with different capacities and data transfer times. The data transfer times for the cache memory levels are directly proportional to the path length from the requestor. As previously mentioned, the first level cache (FLC) memory unit 22 has the shortest transfer time, followed by the second level cache (SLC) memory unit 24, the third level cache (TLC) memory unit 26, and the main memory unit 28. Additional transfer time exists if data is contained in a cache memory unit that is non-local to the requestor. For example, for a request for data by IP11 to MEM0, the memory unit MEM0 is not resident in the same PMM as the CPU IP11, and therefore the memory unit is considered to be non-local to the requestor. If the requestor and the memory unit containing the requested data reside in the same PMM, the memory unit is considered to be local to the requestor.

How to test such an architecture with relatively complete functional coverage, high efficiency and repeatability requires that a number of factors be determined. Initially, knowing the number of requestors is desired, and such information is readily available from the computer's operating system. Also, knowing the number of cache memory levels, the number of units at each level and their capacities is desired, but not normally available. The number of memory units and their respective capacities is information that is only partially available. The total memory capacity of the system can be obtained relatively easily, but there normally is no means for a computer program to directly determine the number of individual memory units. Also, typically it is not possible for a computer program to directly determine how many cache memory units exist at what levels and with what capacities, because these units typically are embedded in the system architecture and are transparent to the end user. A further complication is that most modern computer operating systems use a randomized paging algorithm, which makes it impossible for a user program to determine exactly the memory unit into which a page of data is initially loaded. For example, if four (4) consecutive pages of data are requested by references from IP0, each of these data pages might be initially loaded into a different memory module.

Many conventional cache memory tests use a fixed memory address range and a relatively simplistic method of accessing that range. As sufficient knowledge of the detailed configuration is generally unavailable, it is virtually impossible to test a relatively large and complex configuration with any degree of determinism and reproducibility using conventional test methods and systems. According to an embodiment, the methods, devices and systems described herein address the problem of how to determine the cache memory configuration in a large scale multi-processor computer system, so that the configuration can be used as the basis for conducting cache memory tests that provide a greater degree of architectural and functional coverage than conventional cache memory tests, with an additional advantage being that no operator or end user knowledge is required. Also, the methods, devices and systems described herein enable more deterministic functional and load related tests to be conducted with results capable of being reproduced.

It should be noted that the methods, devices and systems described herein assume that the cache memory system configuration is symmetric, i.e., each of the PMMs have the same cache levels and capacities. However, if the cache memory system configuration is not symmetric, i.e., at least some of the PMMs have different cache levels and capacities, the methods, devices and systems described herein can be modified to account for such differences. Also, it should be noted that the methods, devices and systems described herein assume that all CPU (IP) requestors have the same internal characteristics, e.g., clock speed. The cache memory implementation is system dependent, with some cache memory cache units being inclusive and some cache memory units being exclusive. Also, the methods, devices and systems described herein assume that the cache memory levels are inclusive, although the methods, devices and systems described herein can be adapted to include exclusive cache memory architectures. It is possible to have one cache level be inclusive and another cache level be exclusive. For example, a third level cache (TLC) memory unit can be exclusive and an associated second level cache (SLC) memory unit can be inclusive. In such a system configuration, the write loop timing can be used to differentiate the cache unit characteristics.

According to an embodiment, to determine the number of cache memory levels within a large scale computer system, and the capacities of each cache memory level, a table is built such that the time to access each level and its capacity can be recorded. The method by which this table is built starts by selecting a specific CPU that then writes the address of a single byte of each cacheline contained within an initially-allocated amount of memory to make the data resident in the lowest numerical (smallest and highest speed) cache memory level. This byte generally is a recognizable pattern such as 0x25. The method then reads each address, e.g., multiple times. By reading the same group of addresses multiple times, the read transfer time for each read request can be reliably calculated, as the data will remain resident in the given cache memory unit. The allocated memory size then is increased and the process is repeated. As long as a requested piece of data is resident in a given cache memory level, the read transfer times per request will be consistent. This consistency is true only if no other CPU requestor makes a request for the same data. At some point, the allocated memory size will be increased past the capacity of the initial cache memory level. At that point, the read transfer times per request will increase and the next cache memory level will be entered. This process continues until all cache memory levels and their respective capacities have been detected for the specific CPU. If the cache memory configuration is symmetric, as discussed hereinabove, each CPU will have the same access times to its respective cache memory levels. As a result, a set of tables is constructed by which each CPU and its cache memory levels and timings are identified.

Because of the difference in size between the lowest hierarchical level of data storage (byte) and the smaller unit of cache memory data residency (cacheline), a few process refinements typically are desired. Many modern cache memory units are hierarchically organized into blocks of sets of cachelines of bytes. While the lowest hierarchical level of data storage is normally a byte, the smallest unit of cache data residency is the cacheline. When a byte of data that is non-resident in a particular cache unit is requested, an entire cacheline is read from the next higher hierarchical level and made resident. The requested data byte is then transferred to the requestor. Because the capacity of a cacheline might not be known to the end user, an initial value of either 64 or 128 bytes typically is chosen. However, as will be discussed in greater detail hereinbelow, according to an embodiment, the actual capacity of a cacheline can be determined.

With respect to desired process refinements, as an example, if it has been determined that a particular cache memory level has a capacity 16 KB, with all locations currently resident, a read operation for a non-resident data byte causes an entire cacheline containing the requested byte to be made resident in the next higher hierarchical level before being transferred to the current cache memory level. Subsequent read operations for a data byte in this cacheline will result in the byte being read from the lower cache memory level. However, once the capacity of a particular cache memory level is found or determined, it is desirable to read data from the next higher cache memory level to determine the capacity of that next higher cache memory level. Such determinations are continued until the highest cache memory level of the cache memory architecture is determined.

To facilitate this desired behavior, data should be read on the basis of the smallest unit of cache data residency (e.g., the cacheline) of the cache memory unit architecture. If it is assumed that the lowest value of cache unit residency is a 64 byte cacheline, all data read operations should be conducted on the basis of a single data byte read per cacheline. For example, if the capacity of the Level 1 cache unit is being determined, a trial capacity is chosen. Once the trial capacity is chosen, the entire trial capacity of that cache unit is written once at 1 byte per cacheline, and then repetitively read on the basis of one (1) byte per cacheline. The read timing then is calculated, as will be discussed in greater detail hereinbelow. The trial capacity then is increased and the previous procedure is repeated. At some point, the capacity of the current cache unit will be exceeded as determined by a change in read operation timing. When that point is reached, the capacity of the current cache unit is recorded along with its timing value. The procedure then is applied to the next hierarchical cache unit.

However, if a data byte in a cacheline is read that is resident in a Level 2 cache unit, the entire cacheline will be made resident in the Level 1 cache unit before being sent to the CPU requestor. If another data byte in that cacheline is read, that particular data byte will be read from the Level 1 cache unit because the data byte is being requested from a cacheline that is now resident in the Level 1 cache unit. Such behavior typically is not desirable. However, if only a single data byte is read from a cacheline, each succeeding data byte will be read from a non-Level 1 resident cacheline. This is predicated on the basis that the next lower level cache unit had previously been filled with resident data as part of its detection process. Consequently, each data byte will be read from the Level 2 cacheline prior to being made resident in the Level 1 cache unit and delivered to the CPU requestor. This process is repeated until the capacity of each hierarchical cache unit is determined. By reading data bytes on a cacheline basis, the process insures that each data byte read will be made from a cacheline that is not resident in any cache unit level below the one currently being determined. This process is repeated until all cache memory levels have been detected and their data capacities and access times have been determined.

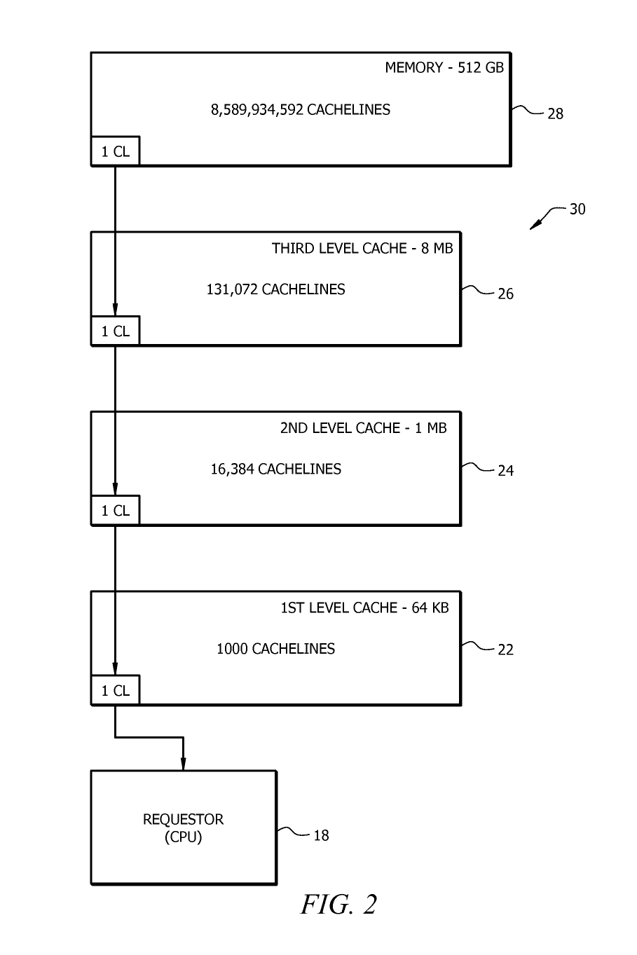

FIG. 2 is a schematic view of a portion 30 of a general system memory hierarchy as it relates to a process for detecting the cache memory levels and determining their respective data capacities and access times according to an embodiment. For purposes of discussion, it is assumed that the cacheline capacity is 64 bytes. In general, according to an embodiment, when a requestor (e.g., a CPU 18) requests data, the data is read from the first level or Level 1 (L1) cache 22 and transferred to the requestor. However, if the requested data is not resident in the Level 1 cache 22, the requested data will be read from the second level or Level 2 (L2) cache 24, made resident in the Level 1 cache 22 and then transferred to the requestor. If the requested data is not resident in the Level 2 cache 24, the requested data will be read from the third level or Level 3 (L3) cache 26, made resident in the lower level caches (i.e., the Level 2 cache 24 and the Level 1 cache 22), as well as sent to the requestor. If the requested data is not resident in the Level 3 cache 26, the requested data will be read from main memory 28, made resident in all cache levels, as well as sent to the requestor.

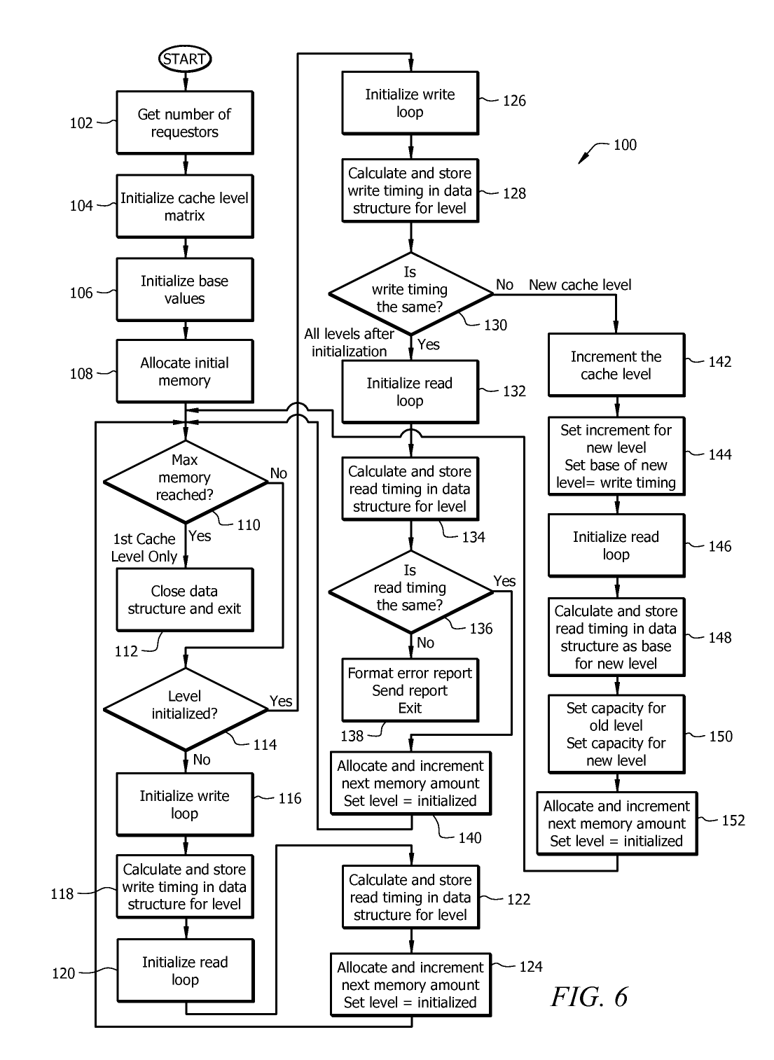

A listing of exemplary process activities for detecting cache memory levels and constructing a table of data capacities and access times for the cache memory levels follows, with continued reference to FIG. 2. The listing, which can be considered to characterize corresponding pseudo-code, will be discussed in greater detail hereinbelow. Also, the number at the end of each listed process activity corresponds to a method step according to embodiments of the invention, e.g., as shown in FIG. 6, which is described hereinbelow.

Initially, a data structure containing an entry for each projected cache memory level can be established. For example, the data structure can be a table having columns for the cache memory level, the detection increment, the detected capacity, the write timing and the read timing. Each row represents each cache memory level.

In general, the process activities for detecting cache memory levels occur as follows. Initially, the data structure is initialized, with the increment values determined by system. An outer loop, whose exit condition of reaching the maximum assigned memory, is entered. Initially, the first projected cache level parameters are not known, thus they are not initialized. The “not initialized” inner loop is entered, and the initial write timing is established, as will be discussed hereinbelow. The corresponding read timing then is established, as will be discussed hereinbelow. Both the write and read timings are stored in the cache memory data structure for the current cache memory level. The size of the allocated portion of the cache memory used for write/read testing is increased by the designated increment, and the timings are recalculated. If the new timings are the same as the previous timings (within the designated margin), the process of incrementing and recalculation is repeated until a new timing is received. When a new timing is received, thus indicating a different cache level, the final capacity of the cache memory level is stored in the current data structure entry. Also, the current capacity and timings are stored in the entry for the next cache level as a base, and the current and new data structure entries are marked as initialized.

This “not initialized” inner loop then is exited. The outer loop then is re-entered. This time, the new cache level data structure will be seen as initialized with the data from the previous level detection, and the inner loop for initialized levels will be entered. The same process for the inner loop is followed, until the maximum testable memory limit has been reached, at which time the detection process is complete. The resulting cache level data structure then can be used by the test program as needed.

It should be noted that the initial write of a cacheline may result in a cache miss, and the data will then have to be made resident. However, by careful choice of the cache level increments, only the initial write to each cacheline in the increment may result in a cache miss. Subsequent writes and reads of that cacheline will be to a resident address.

The process activities are as follows:

Get the number of requestors (102)
Initialize cache level matrix (set projected number of cache/memory levels -
could be left open and dependent on detected results) (104)
Initialize base values (106)
Allocate initial amount of memory (108)
While maximum memory has not been reached (110)

If level has not been initialized (114)

Initialize write loop (116)
Calculate and store write timing in data structure for this level (118)
Initialize read loop (120)
Calculate and store read timing in data structure for this level (122)
Increment and allocate next memory amount (124)
Set level to initialized (124)

Else (114)

Initialize write loop (126)
Calculate and store write timing in data structure for this level (128)
If write timing is the same (same cache level) (130)

Initialize read loop (132)
Calculate and store read timing in data structure for this level

(134)

If read timing is not the same (write timing is the same, read

timing is not - error) (136)

Format error report and exit (138)

Else (136)

Increment and allocate the next amount of memory

(140)

Else (130)

Increment the cache level (new level) (142)
Set memory increment for this new level (144)
Set base write timing for this level = current write timing

(144)

Initialize read loop (146)
Calculate and store read timing in data structure for this level

(148)

Set final capacity for last level = current capacity (150)
Set base capacity for new level = current capacity (150)
Increment and allocate next memory amount (152)

Close data structures (112)
Exit (112)

It should be noted that, at this point in the process activities, each of the cache memory levels has been detected and the level capacity and timing for each of the cache memory levels has been determined. Such determinations should be identical for all requestors in a symmetric configuration.

Once the cache memory level capacities and timings for a single requestor have been determined, a determination is made of whether the cache memory system configuration is symmetric with regard to the data requestor and the architectural cache structures. In the cache memory system configuration shown in FIG. 1, two CPUs 18 share a common second level cache 24 and a common third level cache 26. In this particular configuration, there is a maximum of sixteen (16) such common sharing pairings. Another cache memory system configuration could be configured such that each CPU 18 has its own first level cache 22, its own second level cache 24 and its own third level cache 26, with a shared path to main memory 28 for two CPUs 18. If the configuration is symmetric, a table of cache units and their respective capacities can be constructed according to an embodiment. Although the cache memory system configuration shown in FIG. 1 makes use of paired CPUs 18, each CPU 18 has the identical path length and timing to its respective shared cache units.

According to an embodiment, it can be determined if one or more data requestors share a common cache unit, but the process activities involved in doing so are more complicated, and dependent on whether the cache memory units are either inclusive or exclusive. Although the detailed configuration can be determined via process activities similar to those described hereinabove, it is more important or desirable to determine the number of architectural cache levels, and the capacities and timings of each cache level, than to know the exact configuration of units within each cache level. For purposes of testing, it is slightly less important or desirable to determine whether two (2) CPUs 18 share a second level cache 24 than it is to determine that each CPU 18 will access a second level cache unit 24.

Once the table of data requestors, cache levels and capacities is constructed, the memory configuration is determined according to an embodiment. Referring again to the cache memory hierarchy 10 in FIG. 1, in a maximum configuration it can be seen that an individual data requestor (CPU) can access data located in any one of 16 memory units. The access time to a particular unit can have 1 of 3 timing values, dependent on whether the memory unit containing the requested data is located in the same PMM 16, the same PCM 12 or a remote PCM 12.

Modern computer operating systems typically place data in memory based on a random page allocation algorithm. Hence, when a data requestor allocates an area of memory to test, it cannot be determined programmatically in which physical memory unit the requested data resides. However, to accurately test the entire cache memory complex, it is relatively desirable to know which allocated areas of program memory reside in which physical memory units.

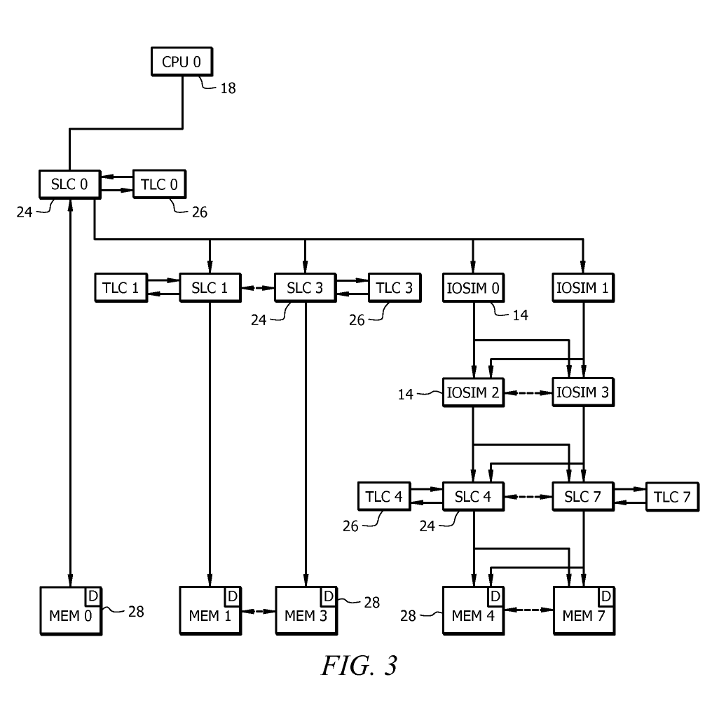

In a cache memory hierarchy like the cache memory hierarchy 10 in FIG. 1, it can be seen that there are three (3) distinct levels of main memory with attendant differences in requestor to data timing. FIG. 3 is a schematic view of a portion of the general system memory hierarchy 10, showing the distinct levels of main memory with attendant difference in requestor-to-data timing.

If a data requestor, such as CPU0 18, has a requirement to write data to memory or read data from memory, the time it takes the data requestor to access the requested data depends on the number of hierarchical levels the data request must traverse. If CPU0 wants to retrieve data that is resident in MEM0 28, the requested data has to pass only through a single second level cache unit 24 (i.e., SLC0) and a single third level cache unit 26 (i.e., TLC0) to travel from memory to the data requestor. However, if CPU0 has a similar requirement to access data in a memory unit 28 in another PMM 16 (e.g., MEM3), the requested data must pass through two (2) second level cache units 24 (i.e., SLC3 and SLC0) and two (2) third level cache units 26 (i.e., TLC3 and TLC0) before reaching the data requestor. Finally, if CPU0 requests data that is resident in a memory unit 28 in another PCM 12 (e.g., MEM4), the requested data must pass through two (2) second level cache units 24 (i.e., SLC4 and SLC0), two (2) third level cache units 26 (i.e., TLC4 and TLC0) and two (2) IOSIM units 14 (i.e., IOSIM 2 and IOSIM0) before reaching the data requestor. Each of these distinct data paths has a different data timing associated therewith. The data path having only a single second level cache unit 24 clearly will access data more rapidly than a data path having two second level cache units 24. The data path that contains both second level cache units 24 and IOSIM units 14 has the longest data transfer timing.

Although the physical memory unit in which requested data resides can not be determined directly, the path length to that requested data can be determined, and subsequently the relative level at which that requested data resides can be determined. If a sufficient number of data areas are allocated as part of the detection process activities, it can be assumed that at least one data area will reside in each physical memory unit. Accordingly, sufficient data areas should be allocated such that the capacity of the largest cache unit (Level 3) is exceeded.

Because data typically is allocated on a random page basis, the total amount of data allocated should be a multiple of the system page size. Because many end users do not know this information, the amount of memory allocated is derived from the detected size of the Level 3 cache memory. At a minimum, the amount of memory allocated uses a binary multiple of the Level 3 cache memory size to allow for effective Level 3 cache memory testing.

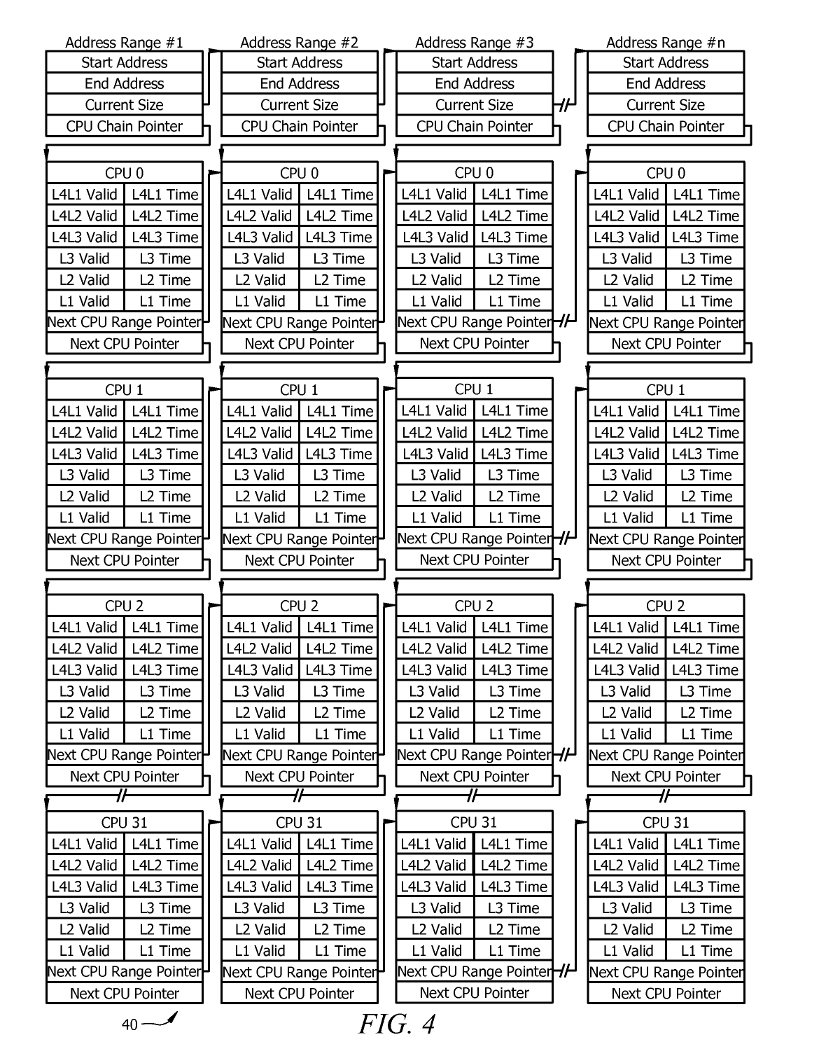

Using this technique, the process activities can build a table showing which data resides at what timing levels for each requestor. FIG. 4 is a schematic view of a table or set of configuration tables 40 built according to an embodiment, showing what data resides as what timing levels for each data requestor. The table 40 is constructed first by selecting a given requestor CPU (e.g., CPU0) and then selecting a piece of requested data that is known not to be resident in any of the memory system's cache memory units. The timing from the requestor CPU to the requested data then is determined and inserted into an address range table. The next incremental piece of requested data then is selected and the data access timing for that requested data is determined. When the entire address range has been checked from the requestor CPU, a distinct timing value has been determined for each piece of requested data, and that value along with the address of the requested data has been entered into the address range table. Then, the same process activities are performed for each of the remaining CPUs. Because data allocation has been chosen in such a way that the cache memory system will not page it out, the data remains in the same physical memory location for the duration of the testing process activities. Hence, the relative physical memory location for each piece of requested data from each requestor CPU will be one of three (3) values, e.g., for a memory system having 3 memory units levels.

Knowing this information, the relative memory configuration can be determined. For example, data located in a physical memory unit 0 will be at timing Level 1 for CPU0 and CPU1, at timing Level 2 from CPU2 through CPU7, and at timing Level 3 for CPU8 through CPU31. Therefore, it can be derived that CPU0 and CPU1 are located in the same PMM 16, CPU2 through CPU7 are located in the same PCM 12, and CPU8 through CPU32 are located in a remote PCM 12. As the detection routine proceeds in sequence from one data byte to the next data byte for each CPU, a table 40 is established that details which CPUs reside at which memory levels relative to each data byte. At this point, there is sufficient information to allow a test program to conduct a comprehensive test activity.

Also, additional information can be gained by correlating the data in the table 40 such that the relationship of each CPU to the other CPUs with regard to architectural level can be determined. For example, using the cache memory hierarchy 10 as a reference, if CPU0 and CPU1 have a Level 1 (shortest) timing to a piece of data resident in MEM0, each of CPU2 through CPU7 has a Level 2 (intermediate) timing to the same piece of data, and each of CPU8 through CPU31 has a Level 3 (longest) timing to the same piece of data, it can be determined that CPU0 and CPU1 exist at the same level with respect to that particular piece of data, CPU2 through CPU7 exist at a different (second or next higher) level with respect to that same piece of data, and CPU8 through CPU31 exist at yet another (third or highest) level with respect to that same piece of data. If this process activity is repeated with a second piece of data that resides in MEM1, it can be determined that CPU2 and CPU3 exist at the same (first) level with respect to the second piece of data, while CPU0, CPU1 and CPU4 through CPU7 exist at the second or next higher timing level, and CPU8 through CPU31 exist at the third or highest timing level.

If this process activity is repeated, e.g., for a piece data that resides in MEM2 and then for a piece of data that resides in MEM3, it can be determined that CPU0 and CPU1, CPU2 and CPU3, CPU4 and CPU5, and CPU6 and CPU7 are paired in a similar level (same PCM) that is different from the remaining CPUs (different PCM). While it is not programmatically possible to determine that a piece of data is in a specific physical memory unit, the same relative physical configuration parameters are determined. Hence, process activities according to an embodiment can determine that CPU0 and CPU1, CPU2 and CPU3, CPU4 and CPU5, and CPU6 and CPU7 are paired and are architecturally separate from the remaining CPUs. As this process activity is extended to the remaining CPUs, a configuration similar to the cache memory hierarchy 10 is determined. The table or set of configuration tables 40 then can be used as an input to an actual test program.

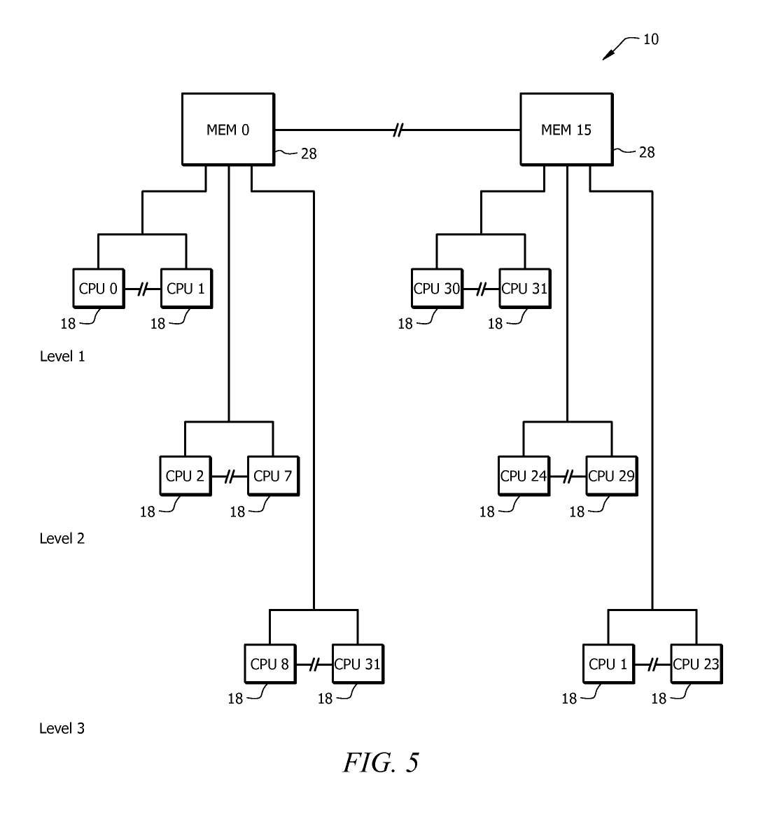

FIG. 5 is a schematic view of a portion of a general system memory hierarchy, showing the distinct levels of main memory with attendant differences in requestor to data timing from the perspective of the main memory (MEM) units. The table 40 in FIG. 4 identifies the data access timing from each CPU to each allocated data area. Assuming a symmetric cache configuration, the timing measurements for each CPU to its respective first, second and third level caches, along with the cache unit capacities, should be the same. The associated data access timings to each data area in memory from each CPU will be one of three timing values, due to the extended path lengths within the system. The table 40 is constructed such that the individual data areas can be accessed by CPUs at a given timing level or, conversely, a CPU can access all data areas at a given timing level. As a result, data can be accessed as either CPU relative, timing level relative, architectural component relative or architectural path relative.

Additional tables also can be constructed that will categorize data as desired to allow more direct access to specific architectural entities. These types of structures facilitate the construction of process activities that allow testing of the entire cache memory architecture in any manner chosen. An added advantage to constructing tables as described hereinabove is that the constructed tables allow the entire CPU complement to be tested using the complete range of deterministic timing conditions. In many cases, a CPU might fail with a particular set of cache memory timings, whereas the CPU might otherwise work.

It should be noted that the embodiments described herein can involve a relatively significant amount of computing to compute and determine the entity relationships described herein. The greater the number of discrete tables that are constructed, the longer the required compute time will be. However, the computing times are not a significant disadvantage because the computing takes place before a test execution has been started. Hence, the computation will not affect the test execution in any way. Also, the results of table computations are stored in a configuration file such that the results might be retrieved and used directly if no configuration changes have been made since the last time a test execution was initiated. Such configuration file eliminates repetitive computational overhead.

FIG. 6 is a flow diagram of a method 100 for determining the configuration of a computer system cache memory unit. As will be seen, the method parallels the pseudo-code process activities listed and described generally hereinabove.

The method 100 includes a step 102 of determining the number of requestors (CPUs) within the cache memory unit of interest. Once the number of requestors has been determined, the method 100 initializes the cache memory level matrix data structure (step 104). As discussed hereinabove, a data structure containing an entry for each projected cache memory level can be established, with data columns for the cache memory level, the detection increment, the detected capacity, the write timing and the read timing. For example, as part of the initializing step 104, for the first memory level, the address increment is set to V1, and the capacity, the read access timing and the write access timing all are set equal to 0. Similarly, for the second memory level, the address increment is set to V2, and the capacity, the read access timing and the write access timing all are set equal to 0. For the nth memory level, the address increment is set to Vn, and the capacity, the read access timing and the write access timing all are set equal to 0.

The method 100 also includes a step 106 of initializing the base values. For example, the base values initializing step 106 can include initializing the cache memory level increment size from the table that was set up as a result of the cache memory level matrix initializing step 104. The base values initializing step 106 also can include initializing the cacheline size to a suitable value, e.g., 64 bytes. The base values initializing step 106 also can include setting the maximum testable memory size to an appropriate value, e.g., 1 terabyte (TB). The base values initializing step 106 also can include setting the cache memory level equal to 1. The method 100 also includes a step 108 of allocating an initial amount of memory to test for this cache memory level, e.g., 1 kilobyte (KB).

The method 100 includes a step 110 of determining whether the current memory size allocated for testing has reached the maximum memory size. If the current memory size allocated for testing has reached the maximum memory size (Y), the method 100 closes the data structure and the method exits or is complete (shown as a step 112). If the current memory size allocated for testing has not reached the maximum memory size (N), the method 100 skips ahead to the next step, i.e., a determining step 114.

The method 100 includes a step 114 of determining whether the cache memory level to be tested has been initialized. If the cache memory level to be tested has not been initialized (N), the method 100 proceeds to a series of steps that collectively establishes reference timings for the first address increment for the current cache memory level being tested (i.e., level 1). In general, this is accomplished by writing 1 byte of data in each cacheline of the current memory allocation to make the data resident and then reading the data byte in each cacheline of the current memory allocation to determine the read timing.

More specifically, the method 100 includes a step 116 of initializing the write loop, i.e., setting the cacheline address equal to 0. The method 100 also includes a step 118 of calculating and storing write timing information in the data structure for the current cache memory level being tested (i.e., level 1). The step 118 includes getting or marking a start write time, writing a byte of data per cacheline throughout the entire amount of memory currently allocated for testing, and then getting or marking the end write time. The step 118 then calculates the write time per byte and stores the result in the appropriate location within the data structure. According to an embodiment, the process of writing a byte of data per cacheline throughout the entire amount of memory currently allocated for testing can be performed multiple times to reduce any effects of the initial write of a cacheline not being resident in the current cache memory level.

The method 100 also includes a step 120 of initializing the read loop, i.e., setting the cacheline address equal to 0. The method 100 also includes a step 122 of calculating and storing read timing information in the data structure for the current cache memory level being tested (i.e., level 1). The step 122 includes getting or marking a start read time, reading a byte of data per cacheline in the entire amount of memory currently allocated for testing, and then getting or marking the end read time. The step 122 then calculates the read time per byte and stores the result in the appropriate location within the data structure. According to an embodiment, the process of reading a byte of data per cacheline throughout the entire amount of memory currently allocated for testing can be performed multiple times to provide a more accurate reference timing than with a single reading.

The method 100 also includes a step 124 of allocating and incrementing the memory amount to be tested. The step 124 includes setting an “initialized” variable equal to 1 to indicate that the current cache memory level (i.e., level 1) now has been initialized. The step 124 also includes allocating memory for the next increment amount of testable cache memory, and increasing the allocation increment to the next increment for this cache memory level. After the step 124 is performed, the method 100 then returns back to the determining step 110.

If the determining step 114 determines that the cache memory level to be tested has been initialized (Y), the method 100 proceeds to a series of steps that collectively establishes reference timings for the current address increment for the current cache memory level being tested. As discussed hereinabove, reference timings generally are established by writing 1 byte of data in each cacheline of the allocated memory to make the data resident and then reading the data byte in each cacheline of the allocated memory to determine the read timing.

More specifically, the method 100 includes a step 126 of initializing the write loop, i.e., setting the cacheline address equal to 0. The method 100 also includes a step 128 of calculating and storing write timing information in the data structure for the current cache memory level being tested. The step 128 includes getting or marking a start write time, writing a byte of data per cacheline throughout the entire amount of memory currently allocated for testing, and then getting or marking the end write time. The step 128 then calculates the write time per byte and stores the result in the appropriate location within the data structure. According to an embodiment, the process of writing a byte of data per cacheline throughout the entire amount of memory currently allocated for testing can be performed multiple times to reduce any effects of the initial write of a cacheline not being resident in the current cache memory level.

The method 100 also includes a step 130 of determining whether the current write timing is substantially the same (within a given margin of error) as the previous write timing. As discussed hereinabove, at some point in the method 100, the allocated memory size will be increased past the capacity of the current cache memory level, and the read transfer times or reference timings (i.e., the write timings and the read timings) per request will increase as a result of the next cache memory level being used during the process of determining the read transfer times. Therefore, if the step 130 determines that the current write timing is substantially the same as the previous write timing (Y), meaning that the same cache memory level is being used, the method 100 proceeds to the read timing portion of the read transfer reference timings.

In this manner, the method 100 includes a step 132 of initializing the read loop, i.e., setting the cacheline address equal to 0. The method 100 also includes a step 134 of calculating and storing read timing information in the data structure for the current cache memory level being tested. The step 134 includes getting or marking a start read time, reading a byte of data per cacheline in the entire amount of memory currently allocated for testing, and then getting or marking the end read time. The step 134 then calculates the read time per byte and stores the result in the appropriate location within the data structure. According to an embodiment, the process of reading a byte of data per cacheline throughout the entire amount of memory currently allocated for testing can be performed multiple times to provide a more accurate reference timing than with a single reading.

The method 100 also includes a step 136 of determining whether the current read timing is substantially the same as the previous read timing. If the current write timing is the same as the previous write timing (i.e., determining step 130=Y), then the current read timing should be substantially the same as the previous read time. If the determining step 136 determines that the current read timing is not the same as the previous read timing (N), the method 100 proceeds to a step 138 of generating an error report.

If the determining step 136 determines that the current read timing is the same as the previous read timing (Y), the method 100 proceeds to a step 140 of allocating and incrementing the next memory amount to be tested. The step 140 includes setting the “initialized” variable to indicate that the new cache memory level is initialized. The step 140 also includes allocating memory for the next increment amount of testable cache memory, and increasing the allocation increment to the next increment for this cache memory level. After the step 140 is performed, the method 100 then returns back to the determining step 110.

As discussed hereinabove, if the determining step 130 determines that the current write timing is substantially the same as the previous write timing (Y), the same cache memory level is being tested. However, if the write transfer time is different than the previous write transfer time, then the next cache memory level is involved in the most recent write timing (and read transfer reference timing) determination process. Therefore, if the determining step 130 determines that the current write timing is not substantially the same as the previous write timing (N), the method 100 proceeds to a series of steps for involving the next cache memory level before proceeding to the read timing portion of the read transfer reference timings for the new cache memory level.

More specifically, the method 100 includes a step 142 of incrementing the cache memory level. For example, if the current cache memory level was Level 1, the step 142 increments the current cache memory level to Level 2. Also, the method 100 includes a step 144 of setting the memory allocation increment for the new cache memory level. The step 144 also sets the current write timing (i.e., from the previous cache memory level) as the base for the write timing of the new cache memory level.

The method 100 then proceeds to the read timing portion of the read transfer reference timings for the new cache memory level. In this manner, the method 100 includes a step 146 of initializing the read loop, i.e., setting the cacheline address equal to 0. The method 100 also includes a step 148 of calculating and storing read timing information in the data structure as the base for the new cache memory level being tested. The step 148 includes getting or marking a start read time, reading a byte of data per cacheline in the entire amount of memory currently allocated for testing, and then getting or marking the end read time. The step 148 then calculates the read time per byte and stores the result in the appropriate location within the data structure (i.e., as the base for the new cache memory level). According to an embodiment, the process of reading a byte of data per cacheline throughout the entire amount of memory currently allocated for testing can be performed multiple times to provide a more accurate reference timing than with a single reading.

The method 100 includes a step 150 of setting the capacity for the previous or old cache memory level, and setting the capacity for the new cache memory level.

After the old and new cache memory levels have been set, the method 100 proceeds to a step 152 of allocating and incrementing the next memory amount to be tested. The step 152 includes setting the “initialized” variable to indicate that the new cache memory level is initialized. The step 152 also includes allocating memory for the next increment amount of testable cache memory, and increasing the allocation increment to the next increment for this cache memory level. After the step 152 is performed, the method 100 then returns back to the determining step 110.

Using the method 100 shown in FIG. 6 and described herein for each requestor (CPU) in the cache memory system, the configuration of the cache memory system is determined, including the number of cache memory levels and the capacities of each of those cache memory levels.

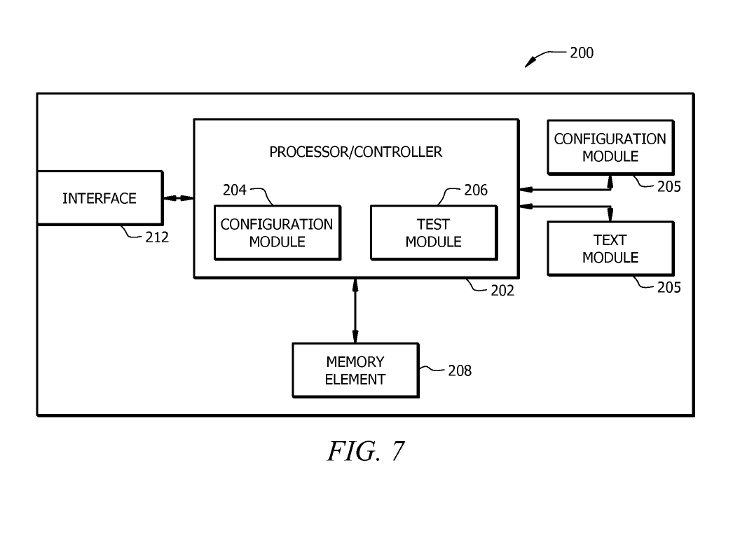

FIG. 7 is a schematic view of an apparatus 200 configured to determine the configuration of a computer system cache memory unit and/or test the cache memory unit according to an embodiment. The apparatus 200 can be any apparatus, device or computing environment suitable for determining the configuration of a computer system cache memory unit and/or testing the cache memory unit according to an embodiment. For example, the apparatus 200 can be or be contained within any suitable computer system, including a mainframe computer and/or a general or special purpose computer.

The apparatus 200 includes one or more general purpose (host) controllers or processors 202 that, in general, processes instructions, data and other information received by the apparatus 200. The processor 202 also manages the movement of various instructional or informational flows between various components within the apparatus 200. The processor 202 can include a cache memory configuration interrogation module (configuration module) 204 that is configured to execute and perform the cache memory unit configuration determining processes described herein. Alternatively, the apparatus 200 can include a stand alone cache memory configuration interrogation module 205 coupled to the processor 202. Also, the processor 202 can include a testing module 206 that is configured to execute and perform the cache memory unit testing processes described herein. Alternatively, the apparatus 200 can include a stand alone testing module 207 coupled to the processor 202.

The apparatus 200 also can include a memory element or content storage element 208, coupled to the processor 202, for storing instructions, data and other information received and/or created by the apparatus 200. In addition to the memory element 208, the apparatus 200 can include at least one type of memory or memory unit (not shown) within the processor 202 for storing processing instructions and/or information received and/or created by the apparatus 200.

The apparatus 200 also can include one or more interfaces 212 for receiving instructions, data and other information. It should be understood that the interface 212 can be a single input/output interface, or the apparatus 200 can include separate input and output interfaces.

One or more of the processor 202, the configuration module 204, the configuration module 205, the testing module 206, the testing module 207, the memory element 208 and the interface 212 can be comprised partially or completely of any suitable structure or arrangement, e.g., one or more integrated circuits. Also, it should be understood that the apparatus 200 includes other components, hardware and software (not shown) that are used for the operation of other features and functions of the apparatus 200 not specifically described herein.

The apparatus 200 can be partially or completely configured in the form of hardware circuitry and/or other hardware components within a larger device or group of components. Alternatively, the apparatus 200 can be partially or completely configured in the form of software, e.g., as processing instructions and/or one or more sets of logic or computer code. In such configuration, the logic or processing instructions typically are stored in a data storage device, e.g., the memory element 208 or other suitable data storage device (not shown). The data storage device typically is coupled to a processor or controller, e.g., the processor 202. The processor accesses the necessary instructions from the data storage element and executes the instructions or transfers the instructions to the appropriate location within the apparatus 200.

One or more of the configuration module 204, the configuration module 205, the testing module 206 and the testing module 207 can be implemented in software, hardware, firmware, or any combination thereof. In certain embodiments, the module(s) may be implemented in software or firmware that is stored in a memory and/or associated components and that are executed by the processor 202, or any other processor(s) or suitable instruction execution system. In software or firmware embodiments, the logic may be written in any suitable computer language. One of ordinary skill in the art will appreciate that any process or method descriptions associated with the operation of the configuration module 204, the configuration module 205, the testing module 206 and/or the testing module 207 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

The functions described may be implemented in hardware, software, firmware, or any combination thereof. If implemented in software, the functions may be stored on or transmitted as one or more instructions or code on a non-transitory computer-readable medium. The methods illustrated in FIG. 6 may be implemented in a general, multi-purpose or single purpose processor. Such a processor will execute instructions, either at the assembly, compiled or machine-level, to perform that process. Those instructions can be written by one of ordinary skill in the art following the description of FIG. 6 and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for determining a cache memory configuration within a computer system, wherein the cache memory includes a plurality of cache memory levels, the method comprising:
allocating a first amount of cache memory from a first memory level of the plurality of cache memory levels;
determining a read transfer time for the allocated amount of cache memory;
increasing the allocation amount of the cache memory;
repeating the read transfer time determining step and the cache memory allocation increasing step until all of the cache memory in all of the cache memory levels has been allocated; and
determining the cache memory configuration based on the determined read transfer times of the plurality of the cache memory levels.

2. The method as recited in claim 1, wherein the computer system includes a CPU, and wherein determining a read transfer time for the allocated amount of cache memory includes the CPU writing data in the allocated cache memory and then reading the data from the allocated cache memory.

3. The method as recited in claim 2, wherein the computer system includes a plurality of CPUs, and wherein determining a read transfer time for the allocated amount of cache memory includes each of the plurality of CPUs writing data in the allocated cache memory and then reading the data from the allocated cache memory.

4. The method as recited in claim 2, wherein the CPU reads the data from the allocated cache memory multiple times.

5. The method as recited in claim 2, wherein the CPU reads the data from the allocated cache memory on a cacheline basis.

6. The method as recited in claim 1, wherein determining the cache memory configuration based on the determined read transfer times of the plurality of the cache memory levels includes building a table configured to record access times and the capacity of each of the plurality of cache memory levels.

7. The method as recited in claim 1, wherein the computer system includes a plurality of CPUs, and wherein the cache memory allocating step, the read transfer time determining step, the cache memory allocation increasing step and the repeating step are performed by each of the plurality of CPUs.

8. The method as recited in claim 1, wherein, when the allocated amount of cache memory exceeds the capacity of the current cache memory level, at least a portion of the next cache memory level becomes part of the allocated amount of cache memory.

9. The method as recited in claim 1, wherein the capacity of a cache memory level is determined based on a change in read transfer time.

10. A computing device, comprising:
a processor;
a memory element coupled to the processor, wherein the memory element includes cache memory having a plurality of cache memory levels; and
a cache memory configuration interrogation module coupled to the processor and to the memory element, wherein the cache memory configuration interrogation module is configured to
allocate a first amount of cache memory from a first cache memory level of the plurality of cache memory levels;
determine a read transfer time for the allocated amount of cache memory;
increase the allocation amount of the cache memory;
repeat the read transfer time determination and the cache memory allocation increase until all of the cache memory in all of the plurality of cache memory levels has been allocated; and
determine the cache memory configuration based on the determined read transfer times of the plurality of the cache memory levels.

11. The computer device as recited in claim 10, wherein each cache memory level includes a plurality of cachelines of data storage units, and wherein the cache memory configuration interrogation module is configured to determine a read transfer time for the allocated amount of cache memory by writing at least one data byte in each cacheline of the allocated amount of cache memory and then reading the at least one data byte in each cacheline of the allocated amount of cache memory.

12. The computer device as recited in claim 11, wherein the cache memory configuration interrogation module is configured to set a start write time, write at least one data byte in each cacheline of the allocated amount of cache memory multiple times, set an end write time, and calculate a write time per byte based on the start write time and the end write time.

13. The computer device as recited in claim 11, wherein the cache memory configuration interrogation module is configured to set a start read time, read at least one data byte in each cacheline of the allocated amount of cache memory multiple times, set an end read time, and calculate a read time per byte based on the start read time and the end read time.

14. The computer device as recited in claim 10, wherein the cache memory configuration interrogation module is configured to write data to the allocated amount of cache memory and read data from the allocated amount of cache memory on a cacheline basis.

15. The computer device as recited in claim 10, wherein the cache memory configuration interrogation module is configured to establish a data structure configured to store data write timings and data read timings for each level of cache memory, and wherein the cache memory configuration interrogation module is configured to determine the cache memory configuration based on the information stored in the data structure.

16. The computer device as recited in claim 10, wherein, when the allocated amount of cache memory exceeds the capacity of the current cache memory level, the cache memory configuration interrogation module allocates at least a portion of the next cache memory level to become part of the allocated amount of cache memory.

17. The computer device as recited in claim 10, wherein the capacity of a cache memory level is determined based on a change in read transfer time.

18. A non-transitory computer readable medium having instructions stored thereon which, when executed by a processor, carry out a method for determining a cache memory configuration, the instructions comprising:
instructions for allocating a first amount of cache memory from a first memory level of a plurality of cache memory levels of the cache memory;
instructions for determining a read transfer time for the allocated amount of cache memory;
instructions for increasing the allocation amount of the cache memory;
instructions for repeating the read transfer time determining step and the cache memory allocation increasing step until all of the cache memory in all of the cache memory levels has been allocated; and
instructions for determining the cache memory configuration based on the determined read transfer times of the plurality of the cache memory levels.

19. The non-transitory computer readable medium as recited in claim 18, wherein the instructions for determining a read transfer time for the allocated amount of cache memory includes instructions for writing at least one data byte in each of a plurality of portions of the allocated amount of cache memory and then reading the at least one data byte in each of the plurality of portions of the allocated amount of cache memory.
